(19) United States
(12) Patent Application Publication
(10) Pub. No.: US 2002/0027844 A1
(43) Pub. Date: Mar. 7, 2002

(54) Optical pickup apparatus

(76) Inventors: Hitoshi Furuhata, Tokorozawa-City (JP); Tomotaka Nishimura, Tokorozawa-City (JP)

Correspondence Address: MORGAN, LEWIS & BOCKIUS, 1800 M STREET NW, WASHINGTON, DC, 20036-5869, US

(21) Appl. No.: 09/925,629

(22) Filed: Aug. 10, 2001

(30) Foreign Application Priority Data
Aug. 22, 2000 (JP) 2000-250676

(51) Int. Cl. G11B 7/095; G11B 7/135

(52) U.S. Cl. 369/44.37; 369/112.1; 369/112.07

(57) ABSTRACT

An optical pickup apparatus has a first light source for emitting a first laser beam, a second light source for emitting a second laser beam whose wavelength is different from that of the first laser beam, a first grating for allowing the first laser beam to pass as a 0th order light, diffracting the second laser beam, and generating a primary diffracted light having an optical axis which closely coincides with that of the first laser beam, and a second grating for using the laser beam supplied from the first grating as a main beam and generating sub-beams for generating a tracking error signal of a three-beam method with respect to the main beam, wherein the first and second light sources and the first and second gratings are constructed as an integrated unit, and the unit is held in a holding member for holding the optical parts of the optical system.

### BACKGROUND OF THE INVENTION

1. Field of the Invention

The invention relates to an optical pickup apparatus which emits a plurality of laser beams of different wavelengths and can read recorded information from a plurality of kinds of optical discs of different recording densities.

2. Description of the Related Art

Generally, a semiconductor laser device is used as a light source of an optical pickup apparatus for playing an optical information recording medium such as CD, DVD, or the like.

To play back the recording medium, the light emission wavelength and the numerical aperture (NA) of an objective lens of the semiconductor laser device which is used for playing a CD and for playing a DVD are different from each other. For example, in the case of the DVD, the wavelength is equal to 650 nm and the NA is equal to 0.6 and, in the case of the CD, the wavelength is equal to 780 nm and the NA is equal to 0.45.

To play different kinds of discs such as CD and DVD by one disc player, therefore, an optical pickup apparatus having therein light sources of two wavelengths of 650 nm and 780 nm is being used. FIG. 1 shows an example of the optical pickup apparatus.

According to the optical pickup apparatus shown in FIG. 1, a laser device 1 for emitting a laser beam having a wavelength of 650 nm, a laser device 2 for emitting a laser beam having a wavelength of 780 nm, a synthesizing prism 3, a half mirror 4, a collimator lens 5, and an objective lens 6 are sequentially arranged. Further, a cylindrical lens (not shown) and a photodetector 7 are placed on another optical axis which is branched from the half mirror 4. In the construction, since an optical system starting with the synthesizing filter 3 and extending to an optical disc 8 is used in common for the CD and DVD, in both cases, the light emitted from the laser device passes through the synthesizing filter 3 and, thereafter, is guided toward the optical disc 8 along an optical axis Y. The objective lens 6 used here is a lens having double focal points and different focal positions, provided in accordance with the two wavelengths. A spherical aberration which is caused by different thicknesses of surface substrates of the CD and DVD can be, consequently, suppressed.

In the construction, however, since a synthesizing prism or the like is needed, a large number of parts is required and production costs are high. Further, because it is necessary to match the positions of the two laser devices and the synthesizing prism, the construction becomes complicated, and it is difficult to make adjustments to the device.

### SUMMARY OF THE INVENTION

In consideration of the problems, it is an object of the present invention to provide an optical pickup apparatus in which a construction of the apparatus for using a plurality of laser beams having different wavelengths can be simplified and miniaturized.

According to the present invention, there is provided an optical pickup apparatus comprising: a light emitting device having at least a first light source for emitting a first laser beam and a second light source for emitting a second laser beam having a wavelength different from that of the first laser beam and in which the first and second light sources are closely arranged; an optical system formed with an irradiation optical path for guiding the laser beam toward a recording medium and a reflection optical path for guiding a reflected laser beam by the recording medium toward a photodetector; and a holding member for holding optical parts of the optical system, wherein on the irradiation optical path near an arranging position of the light emitting device, the optical system includes a first grating for allowing the first laser beam to pass as a 0th order light, diffracting the second laser beam, and generating a primary diffracted light having an optical axis which closely coincides with an optical axis of the first laser beam and a second grating for using the laser beam supplied from the first grating as a main beam and generating sub-beams for generating a tracking error signal according to a three-beam method with respect to the main beam, and the holding member holds a unit in which the light emitting device and the first and second gratings are integrated.

According to the invention, there is provided an optical pickup apparatus comprising: a light emitting device having at least a first light source for emitting a first laser beam and a second light source for emitting a second laser beam having a wavelength different from that of the first laser beam and in which the first and second light sources are closely arranged; an optical system formed with an irradiation optical path for guiding the laser beam toward a recording medium and a reflection optical path for guiding a reflected laser beam by the recording medium toward a photodetector; and a holding member for holding optical parts of the optical system, wherein on the irradiation optical path near an arranging position of the light emitting device, the optical system includes a brazed hologram device for allowing the first laser beam to pass as a 0th order light, diffracting the second laser beam, and generating a primary diffracted light, as a main beam, having an optical axis which closely coincides with an optical axis of the first laser beam, and the holding member holds a unit in which the light emitting device and the brazed hologram device are integrated.

According to the invention, there is provided a semiconductor laser unit for an optical pickup apparatus, comprising: a light emitting device having at least a first light source for emitting a first laser beam and a second light source for emitting a second laser beam having a wavelength different from that of the first laser beam and in which the first and second light sources are closely arranged; a first grating for allowing the first laser beam to pass as a 0th order light, diffracting the second laser beam, and generating a primary diffracted light having an optical axis which closely coincides with an optical axis of the first laser beam; a second grating for using the laser beam supplied from the first grating as a main beam and generating sub-beams for generating a tracking error signal of a three-beam method with respect to the main beam; and a holding member for holding the light emitting device and the first and second gratings in an integrated form.

According to the present invention, there is provided a semiconductor laser unit for an optical pickup apparatus, comprising: a light emitting device having at least a first light source for emitting a first laser beam and a second light source for emitting a second laser beam having a wavelength different from that of the first laser beam and in which the first and second light sources are closely arranged; a brazed hologram device for allowing the first laser beam to pass as a 0th order light, diffracting the second laser beam, and generating a primary diffracted light, as a main beam, having an optical axis which closely coincides with an optical axis of the first laser beam; and a holding member for holding the light emitting device and the brazed hologram device in an integrated form.

### BRIEF DESCRIPTION OF THE DRAWINGS

FIG. 1 is a constructional diagram showing an example of a conventional optical pickup apparatus;

FIG. 2 is a diagram showing an optical system of an optical pickup apparatus as an embodiment of the present invention;

FIG. 3 is a diagram showing a cross section of a hologram device in the optical system of FIG. 2;

FIGS. 4A and 4B are diagrams showing position adjustment of a spot light according to a three-beam method in the apparatus of FIG. 1;

FIG. 5 is a cross sectional view showing details of a semiconductor laser device;

FIG. 6 is a diagram showing a pattern on a photosensing surface of a photodetector in the apparatus of FIG. 1;

FIG. 7 is a diagram showing a cross section of another hologram device and its operation; and

FIG. 8 is a diagram showing a cylindrical holder portion of an optical pickup apparatus according to another embodiment of the invention.

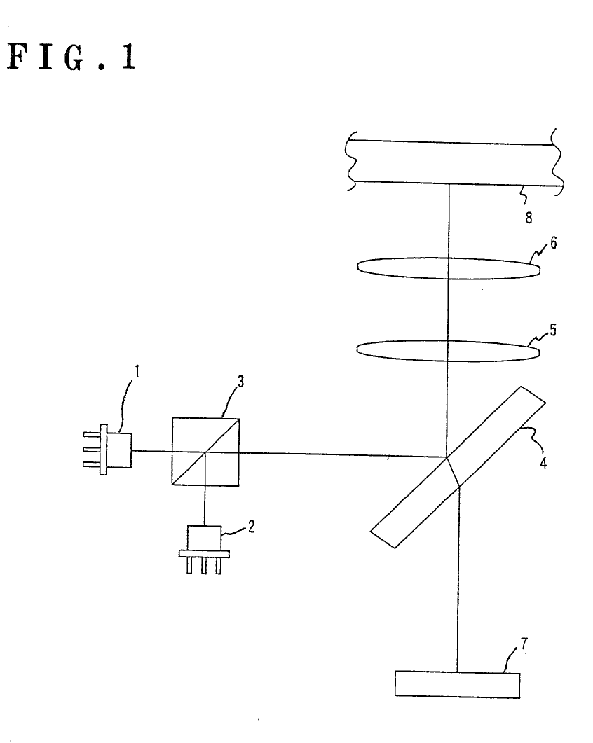

### DETAILED DESCRIPTION OF THE PREFERRED EMBODIMENT

An embodiment of the invention will now be described in detail hereinbelow with reference to the drawings.

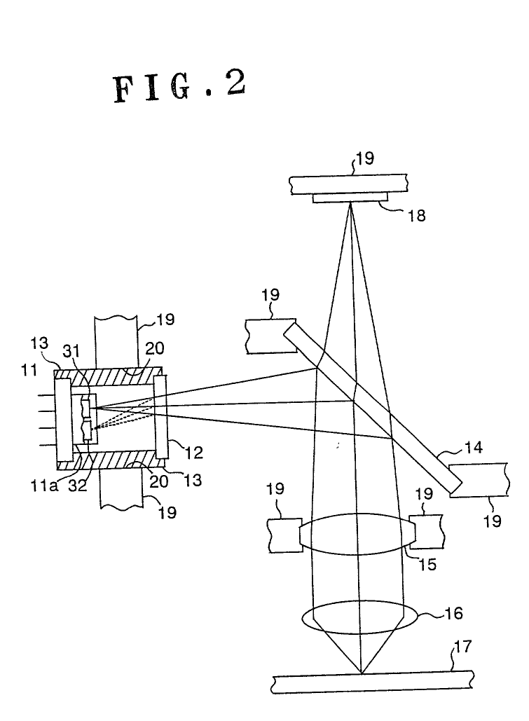

FIG. 2 shows an optical system of an optical pickup apparatus according to the present invention. In the optical pickup apparatus, a semiconductor laser device 11 for emitting two laser beams of different wavelengths and a hologram device 12 for diffracting the laser beam are attached to a cylindrical holder 13 and integrated. The cylindrical holder 13 is hollow and has opening portions at both ends. The semiconductor laser device 11 is fixed to one of the opening portions of the cylindrical holder 13. The hologram device 12 is fixed to the other opening portion of the cylindrical holder 13.

The semiconductor laser device 11 individually emits a first laser beam having a wavelength of 650 nm and a second laser beam having a wavelength of 780 nm from different light emitting points which are arranged toward a same emitting direction. An interval L between the light emitting points is equal to about 100 μm.

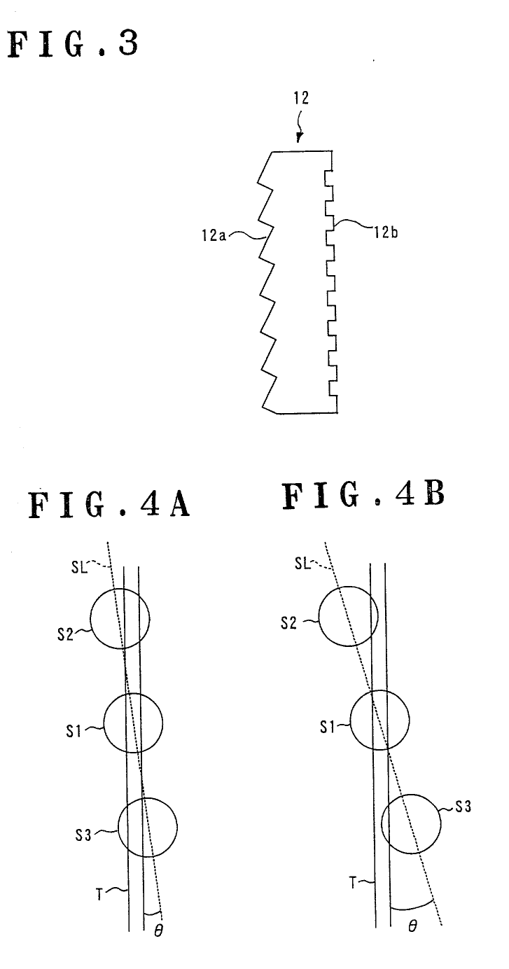

As shown in FIG. 3, the hologram device 12 has a first grating 12a and a second grating 12b. The first grating 12a is brazed and formed on one of the surfaces of a substrate of the hologram device 12, that is, on the surface locating on the side of the semiconductor laser device 11 and diffracts the second laser beam so that an optical axis of a primary diffracted light of the second laser beam of the wavelength of 780 nm coincides with an optical axis of a 0th order light of the first laser beam of the wavelength of 650 nm. That is, one of the 0th order light of the first laser beam which passed through the first grating 12a and one of ± primary diffracted lights (having positive and negative polarities) of the second laser beam is used as a main beam (beam for reading information) which is irradiated onto a disc 17. As shown in FIG. 3, the brazed hologram is a hologram on which a sawtooth-shaped grating has been formed and can set a ratio of positive and negative light amounts of high-order diffracted light in accordance with an angle of inclination of the saw teeth. In the embodiment, use efficiency of the second laser beam is improved by setting the inclination angle so that the amount of light which is used as a main beam of the ± primary diffracted lights of the second laser beam becomes larger.

The second grating 12b is formed on the other surface of the substrate of the hologram device 12, that is, on the surface locating on the side of a half mirror 14, which will be explained hereinlater, diffracts the primary light of the second laser beam of the wavelength of 780 nm, and newly emits ± primary diffracted lights. The ± primary diffracted lights are used for generating a tracking error signal.

In the case of attaching the semiconductor laser device 11 and hologram device 12 to the cylindrical holder 13, the semiconductor laser device 11 is fixedly bonded to the cylindrical holder 13 with an adhesive agent (not shown). The hologram device 12 is rotated so that the optical axis of the primary diffracted light of the second laser beam of the wavelength of 780 nm coincides with the optical axis of the first laser beam of the wavelength of 650 nm, and is positioned against the semiconductor laser device 11. After that, the hologram device 12 is fixedly bonded to the cylindrical holder 13 with the adhesive agent. It is also possible to use a method whereby the hologram device 12 is previously fixed to the cylindrical holder 13, the semiconductor laser device 11 is rotated in order to position against the hologram device 12, and after that, the hologram device 12 is fixed to the cylindrical holder 13.

In the case of performing a tracking servo control by the three-beam method, the positions of three spot lights formed on a disc are adjusted by rotating the cylindrical holder 13 to an optical pickup apparatus body 19. That is, an attaching hole 20 for supporting the cylindrical holder 13 is formed in the body 19 of the optical pickup apparatus. The cylindrical holder 13 is rotatable in the attaching hole 20 before being fixedly bonded with the adhesive agent. The cylindrical holder 13 to which the semiconductor laser device 11 and hologram device 12 have been fixed is inserted into the attaching hole 20. As shown in FIG. 4A, according to the position adjustment of the three spot lights, three circular spot lights S1 to S3 are formed onto a track T of the disc. A center of each of the spot lights S1 to S3 is located on a straight line SL connecting them. The spot light S1 is a spot light of the main beam. In the tracking servo control by the three-beam method, the spot lights S2 and S3 of sub-beams are used so that the spot light S1 is located at the center of the track T. By rotating the cylindrical holder 13, an angle θ formed by the straight line SL and track T (accurately, a tangential line of the track T) can be varied as shown in FIG. 4B. By the position adjustment of the spot lights, for example, the spot lights S2 and S3 are located almost on a mirror surface of the disc so as to slightly include the track T. At this time, since the relative positional relation among the light emitting points of the first and second laser beams and the first grating 12a and second grating 12b is always maintained, a deviation is not caused in the relation between the 0th order light of the first laser beam and the primary light of the second laser beam by the rotation adjustment. By making the rotational center of the cylindrical holder 13 coincide with the center of the spot light S1, the position adjustment can be easily performed. After the position adjustment of the spot lights, the cylindrical holder 13 is fixed to the optical pickup apparatus body 19 with, for example, the adhesive agent.

In the optical system of the optical pickup apparatus, the half mirror 14 reflects the laser beam which passed through the hologram device 12. The laser beam reflected by the half mirror 14 reaches a disc 17 while sequentially passing through a collimator lens 15 and an objective lens 16. The collimator lens 15 converts the laser beam from the half mirror 14 into a parallel light and supplies it to the objective lens 16. The objective lens 16 is a double-focal-point lens and converges the laser beam as a parallel light onto the recording surface of the disc 17. A DVD and a CD (including a CD-R) are used as a disc 17. One of those discs is loaded onto a turntable (not shown).

The laser beam reflected by the recording surface of the disc 17 is converted into a parallel light laser beam by the objective lens 16, is converted into the converged laser beam by the collimator lens 15, and passes through the half mirror 14 while being slightly refracted. The laser beam which passed through the half mirror 14 reaches a photodetector 18.

Optical parts such as half mirror 14, collimator lens 15, and photodetector 18 are fixed to the body 19 as a holding member. Although not shown in FIG. 2, the objective lens 16 is movably fixed to the body 19 of the optical pickup apparatus through a focusing actuator and a tracking actuator (both are not shown). Although the body 19 of the optical pickup apparatus is segmentally illustrated in FIG. 2, the body 19 is a single body.

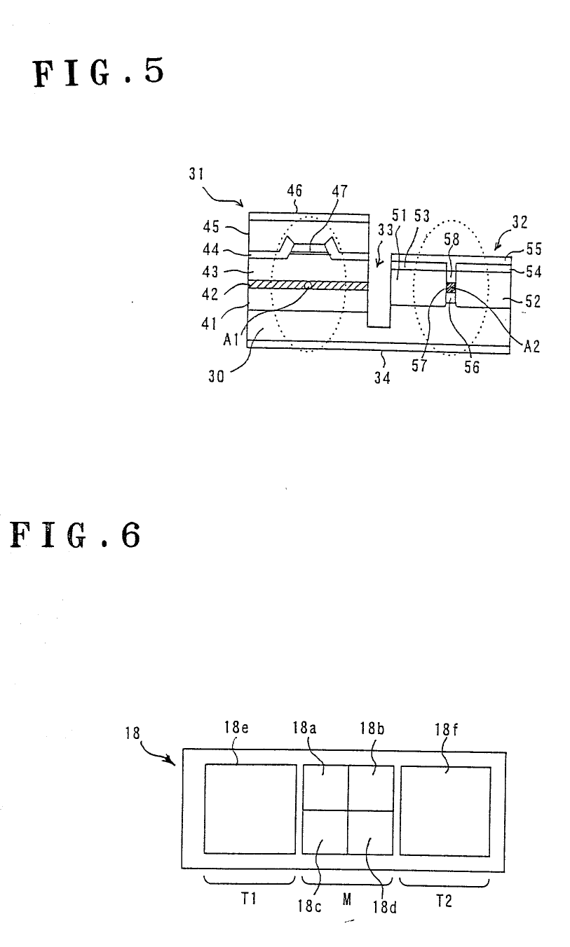

FIG. 5 shows a cross section of a chip of the semiconductor laser device 11. As shown in FIG. 5, the semiconductor laser device 11 is a monolithic type formed as one chip. A first light emitting unit 31 having a first light emitting point A1 for emitting the first laser beam of a wavelength of 650 nm and a second light emitting unit 32 of a second light emitting point A2 for emitting the second laser beam of a wavelength of 780 nm are formed on one of principal surfaces of a single n-type GaAs substrate 30 through a separating groove 33. Each of the first light emitting unit 31 and second light emitting unit 32 have a laminated structure as will be explained hereinlater. A back electrode 34 serving as a common electrode of both light emitting units 31 and 32 is formed on the other principal surface of the substrate 30. The light emitting surface of the first light emitting unit 31 having the light emitting point A1 and the light emitting surface of the second light emitting unit 32 having the emitting point A2 are directed in the same emitting direction.

The first light emitting unit 31 has an n-type AlGaInP clad layer 41, a strain quantum well active layer 42, a p-type AlGaInP clad layer 43, an n-type GaAs layer 44, a p-type GaAs layer 45, and an electrode 46 in order from the GaAs substrate 30. A center portion of a cross section of the clad layer 43 is formed in a trapezoidal shape. The n-type GaAs layer 44 is formed so as to cover the clad layer 43 excluding the trapezoidal top surface. A p-type GaInP layer 47 is formed on the trapezoidal top surface. The first light emitting point A1 is located on the strain quantum well active layer 42.

The second light emitting unit 32 has what is called a double hetero structure. A pair of n-type AlGaAs buried layers 51 and 52 are arranged on the GaAs substrate 30 with a predetermined gap. One electrode 55 is provided over the pair of n-type AlGaAs buried layers 51 and 52 through insulating layers 53 and 54. An n-type AlGaAs clad layer 56, an undoped GaAs active layer 57, and a p-type AlGaAs clad layer 58 are sequentially laminated on the GaAs substrate 30 between the buried layers 51 and 52. The clad layer 58 is in contact with the electrode 55. The second light emitting point A2 is located in the active layer 57. An interval between the optical axis from the first light emitting point A1 and the optical axis from the second light emitting point A2 is equal to, for example, 100 μm.

The semiconductor laser device 11 is fixed into an insulating sub mount and they are further covered by a casing member 11a as shown in FIG. 2.

The semiconductor laser device 11 is driven by a laser driving circuit (not shown). The laser driving circuit drives the semiconductor laser device 11 so as to selectively emit either the first laser beam or the second laser beam in accordance with a kind of disc 17 from which recorded information should be read. That is, the laser driving circuit drives the semiconductor laser device 11 so as to selectively emit the first laser beam of the wavelength of 650 nm when the disc 17 is a DVD. The laser driving circuit drives the semiconductor laser device 11 so as to selectively emit the second laser beam of the wavelength of 780 nm when the disc 17 is a CD.

As shown in FIG. 6, the photosensing surface of the photodetector 18 includes three square areas T1, M, and T2 and these areas are arranged in a line in the same plane in that order. The area M is positioned between the areas T1 and T2 and divided into four parts crosswise. The divided parts are formed by photosensitive devices 18a to 18d. Photosensing surfaces of the photosensitive devices 18a and 18d are symmetrical around a dividing cross point as a center. Photosensing surfaces of the photosensitive devices 18b and 18c are symmetrical around a dividing cross point as a center. The areas T1 and T2 are tracking areas of the three-beam method and formed by photosensitive devices 18e and 18f.

In the optical system of the optical pickup apparatus according to the invention shown in FIG. 2, when the disc 17 is a DVD, the semiconductor laser device 11 emits a first laser beam (solid line in FIG. 2) of the wavelength of 650 nm by the selective driving of the laser driving circuit. A 0th order light of the first laser beam passes through the first grating 12a and second grating 12b of the hologram device 12 as it is and reaches the half mirror 14. The 0th order light of the first laser beam reflected by the half mirror 14 reaches the disc 17 through the collimator lens 15 and objective lens 16. The 0th order light of the first laser beam reflected by the recording surface of the disc 17 reaches the area M of the photosensing surface of the photodetector 18 through the objective lens 16, collimator lens 15, and half mirror 14.

A read signal RF, a tracking error signal TE, and a focusing error signal FE are generated in accordance with output signals of the photosensitive devices 18a to 18d, respectively. Assuming that the output signals of the photosensitive devices 18a to 18d are set to a, b, c, and d in order, respectively, the read signal RF is calculated as follows:

RF=a+b+c+d.

The tracking error signal TE is calculated by a phase difference method as follows:

TE=(a′+d′)−(b′+c′).

Reference characters a′, b′, c′, and d′ denote signals calculated by phase comparing the signals a, b, c, and d with the read signal RF.

The focusing error signal FE is calculated by an astigmatism method as follows:

FE=(a+d)−(b+c).

The read signal RF, focusing error signal FE, and tracking error signal TE are generated by an arithmetic operating circuit (not shown).

When the disc 17 is a CD, the semiconductor laser device 11 emits a second laser beam (broken line in FIG. 2) of the wavelength of 780 nm by the selective driving of the laser driving circuit. The second laser beam is diffracted by a diffracting operation of the first grating 12a of the hologram device 12 in a manner such that a + primary light becomes maximum and its optical axis coincides with the optical axis of a 0th order light of the first laser beam. When the + primary light of the second laser beam becomes the main beam and reaches the second grating 12b of the hologram device 12, ± primary lights regarding the + primary light of the second laser beam are generated due to the diffracting operation by the second grating 12b. The ± primary lights are used as sub-beams for tracking of the three-beam method.

The second laser beam which passed through the hologram device 12 is reflected by the half mirror 14 and, thereafter, reaches the disc 17 through the collimator lens 15 and objective lens 16. Each order light of the second laser beam reflected by the recording surface of the disc 17 reaches the areas T1, M, and T2 of the photosensing surface of the photodetector 18 through the objective lens 16, collimator lens 15, and half mirror 14. That is, the main beam of the second laser beam forms the spot light onto the area M and the tracking sub-beams form spot lights onto the areas T1 and T2, respectively.

The read signal RF and focusing error signal FE are generated in accordance with the output signals of the photosensitive devices 18a to 18d. The tracking error signal TE is generated in accordance with the output signals of the photosensitive devices 18e to 18f. Assuming that the output signals of the photosensitive devices 18a to 18f are set to a to f in order, the read signal RF is calculated as follows:

RF=a+b+c+d.

The tracking error signal TE is calculated by the three-beam method as follows:

TE=e−f.

The focusing error signal FE is calculated by the astigmatism method as follows:

FE=(a+d)−(b+c).

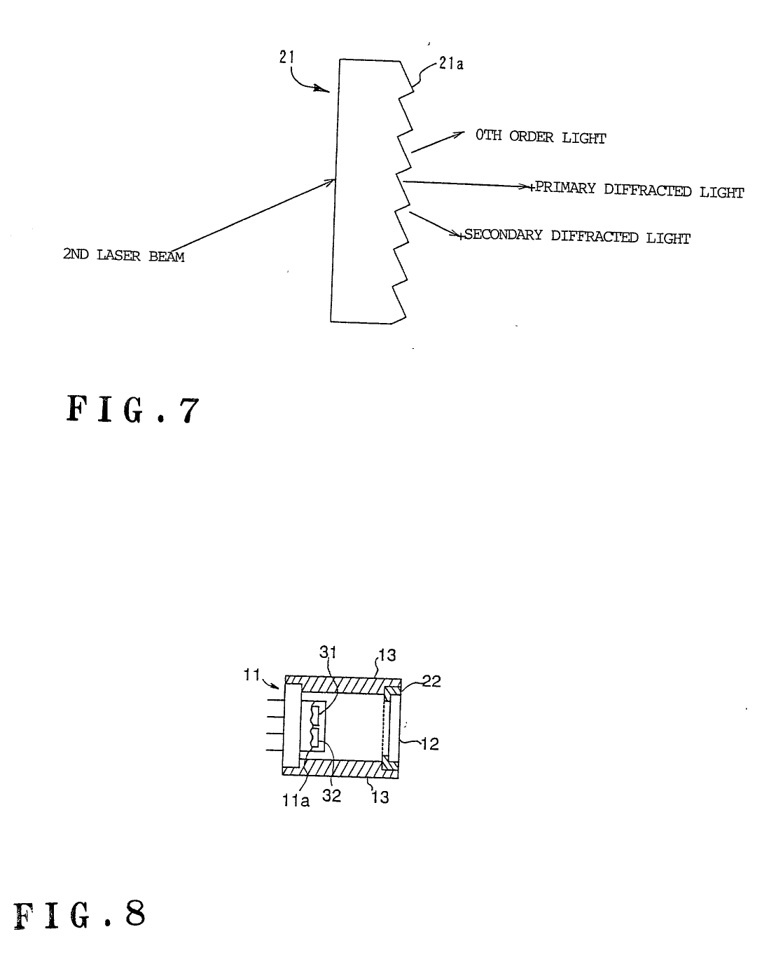

In the embodiment, the hologram device 12 is not limited to the device having the first and second gratings 12a and 12b as shown in FIG. 3. For example, as shown in FIG. 7, a brazed hologram device 21 can be used. A saw-tooth-shaped grating 21a is formed on one of the surfaces of the brazed hologram device 21. In the optical system, the grating 21a is located on the half mirror 14 side. Although a first laser beam of the wavelength of 650 nm is not diffracted by the grating 21a, a second laser beam of the wavelength of 780 nm is diffracted. As shown in FIG. 7, a + primary diffracted light of the second laser beam becomes maximum, its optical axis is made to coincide with the optical axis of the first laser beam, and this + primary diffracted light becomes the main beam. A 0th order light and a + secondary diffracted light of the second laser beam are diffracted in order to use them as tracking sub-beams of the three-beam method. A light amount of each of the 0th order light and the + secondary diffracted light is set to almost the same level in the brazed hologram device 21 and to be lower than that of the + primary diffracted light.

In the embodiment shown in FIG. 2, the hologram device 12 is directly fixed to the cylindrical holder 13. As shown in FIG. 8, however, it is also possible to construct the apparatus in a manner such that the hologram device 12 is fixedly bonded to a hologram holder 22 and attached thereto, the semiconductor laser device 11 and hologram device 12 are mutually positioned by rotating the hologram holder 22 including the hologram device 12 so that the optical axis of the primary diffracted light of the second laser beam of the wavelength of 780 nm coincides with the optical axis of the first laser beam of the wavelength of 650 nm, and thereafter, the hologram holder 22 is fixedly bonded to the other opening portion of the cylindrical holder 13 and attached thereto.

According to the invention as mentioned above, the optical pickup apparatus can be formed in a compact size. Further, the tracking servo control can be stably performed by merely making the simple adjustment.

This application is based on a Japanese Patent Application No. 2000-250676 which is hereby incorporated by reference.

What is claimed is:

1. An optical pickup apparatus comprising:
a light emitting device having at least a first light source for emitting a first laser beam and a second light source for emitting a second laser beam having a wavelength different from that of said first laser beam and in which said first and second light sources are closely arranged;
an optical system formed with an irradiation optical path for guiding said laser beam toward a recording medium and a reflection optical path for guiding a reflected laser beam by said recording medium toward a photodetector; and
a holding member for holding optical parts of said optical system,
wherein on said irradiation optical path near an arranging position of said light emitting device, said optical system includes a first grating for allowing said first laser beam to pass as a 0th order light, diffracting said second laser beam, and generating a primary diffracted light having an optical axis which closely coincides with an optical axis of said first laser beam and a second grating for using the laser beam supplied from said first grating as a main beam and generating sub-beams for generating a tracking error signal according to a three-beam method with respect to said main beam, and
said holding member holds a unit in which said light emitting device and said first and second gratings are integrated.

2. An apparatus according to claim 1, wherein said first and second gratings are formed by a single hologram device.

3. An apparatus according to claim 2, wherein said hologram device is a device in which said first grating is formed on a surface of a plate-shaped substrate and said second grating is formed on another surface of said plate-shaped substrate.

4. An apparatus according to claim 2, wherein said first grating is brazed in said hologram device.

5. An apparatus according to claim 1, wherein an amount of light of said primary diffracted light becomes larger than that of another primary diffracted light having a different polarity in said first grating.

6. An apparatus according to claim 1, wherein a wavelength of said first laser beam is shorter than that of said second laser beam.

7. An optical pickup apparatus comprising:
a light emitting device having at least a first light source for emitting a first laser beam and a second light source for emitting a second laser beam having a wavelength different from that of said first laser beam and in which said first and second light sources are closely arranged;
an optical system formed with an irradiation optical path for guiding said laser beam toward a recording medium and a reflection optical path for guiding a reflected laser beam by said recording medium toward a photodetector; and
a holding member for holding optical parts of said optical system,
wherein on said irradiation optical path near an arranging position of said light emitting device, said optical system includes a brazed hologram device for allowing said first laser beam to pass as a 0th order light, diffracting said second laser beam, and generating a primary diffracted light, as a main beam, having an optical axis which closely coincides with an optical axis of said first laser beam, and
said holding member holds a unit in which said light emitting device and said brazed hologram device are integrated.

8. An apparatus according to claim 7, wherein in said brazed hologram device, a hologram brazed in a saw-tooth shape is formed on a surface of a plate-shaped substrate, and the surface is provided for said unit so as to be directed toward a direction opposite to said light emitting device.

9. An apparatus according to claim 7, wherein said brazed hologram device generates a 0th order light and a secondary diffracted light of said second laser beam as sub-beams for generating a tracking error signal of a three-beam method.

10. An apparatus according to claim 7, wherein said brazed hologram device provides an amount of light of a 0th order light of said second laser beam to closely coincide with an amount of light of a secondary diffracted light whose polarity is the same as that of said primary diffracted light.

11. An apparatus according to claim 7, wherein a wavelength of said first laser beam is shorter than that of said second laser beam.

12. A semiconductor laser unit for an optical pickup apparatus, comprising:
a light emitting device having at least a first light source for emitting a first laser beam and a second light source for emitting a second laser beam having a wavelength different from that of said first laser beam and in which said first and second light sources are closely arranged;
a first grating for allowing said first laser beam to pass as a 0th order light, diffracting said second laser beam, and generating a primary diffracted light having an optical axis which closely coincides with an optical axis of said first laser beam;
a second grating for using the laser beam supplied from said first grating as a main beam and generating sub-beams for generating a tracking error signal of a three-beam method with respect to said main beam; and
a holder for holding said light emitting device and said first and second gratings in an integrated form.

13. A unit according to claim 12, wherein said first and second gratings are formed by a single hologram device.

14. A unit according to claim 13, wherein said hologram device has said first grating formed on a surface of a plate-shaped substrate and said second grating formed on another surface of said plate-shaped substrate.

15. A unit according to claim 13, wherein said first grating is brazed in said hologram device.

16. A unit according to claim 12, wherein an amount of light of said primary diffracted light becomes larger than that of another primary diffracted light having a different polarity in said first grating.

17. A unit according to claim 12, wherein a wavelength of said first laser beam is shorter than that of said second laser beam.

18. A semiconductor laser unit for an optical pickup apparatus, comprising:
a light emitting device having at least a first light source for emitting a first laser beam and a second light source for emitting a second laser beam having a wavelength different from that of said first laser beam and in which said first and second light sources are closely arranged;
a brazed hologram device for allowing said first laser beam to pass as a 0th order light, diffracting said second laser beam, and generating a primary diffracted light, as a main beam, having an optical axis which closely coincides with an optical axis of said first laser beam; and
a holder for holding said light emitting device and said brazed hologram device in an integrated form.

19. A unit according to claim 18, wherein in said brazed hologram device, a hologram brazed in a saw-tooth shape is formed on a surface of a plate-shaped substrate, and the surface is provided for said unit so as to be directed in an opposite direction to said light emitting device.

20. A unit according to claim 18, wherein said brazed hologram device generates a 0th order light and a secondary diffracted light of said second laser beam as sub-beams for generating a tracking error signal of a three-beam method.

21. A unit according to claim 18, wherein said brazed hologram device provides an amount of light of a 0th order light of said second laser beam to closely coincide with an amount of light of a secondary diffracted light whose polarity is the same as that of said primary diffracted light.

22. A unit according to claim 18, wherein a wavelength of said first laser beam is shorter than that of said second laser beam.
